(19) United States
(12) Patent Application Publication
(10) Pub. No.: US 2025/0119007 A1
(43) Pub. Date: Apr. 10, 2025

(54) Brushless Electric Machine with Balance Ring Diodes

(71) Applicant: BorgWarner Inc., Auburn Hills, MI (US)

(72) Inventors: David A. Fulton, Anderson, IN (US); Matthew R. Conner, Franklin, IN (US); Kirk Neet, Noblesville, IN (US)

(21) Appl. No.: 18/906,627

(22) Filed: Oct. 4, 2024

Related U.S. Application Data
(60) Provisional application No. 63/588,975, filed on Oct. 9, 2023.

(51) Int. Cl. H02K 1/26; H01F 38/18; H02K 11/00; H02K 11/042

(52) U.S. Cl. CPC H02K 1/26; H01F 38/18; H02K 11/0094; H02K 11/042; H02K 2211/03

(57) ABSTRACT

A brushless electric machine includes a housing, a stator assembly, a rotor assembly, a rotary transformer, and a rectifier. The stator assembly is arranged within the housing and includes a stator winding provided on a stator core. The rotor assembly is also positioned within the housing with an airgap separating the rotor assembly from the stator assembly. The rotor assembly includes a rotor shaft, a rotor winding, and a balance ring. The rotary transformer is positioned within the housing and includes a primary coil and a secondary coil. The rectifier includes a plurality of diodes positioned on the balance ring. The rectifier is electrically connected between the secondary coil and the rotor winding.

### CROSS-REFERENCE TO RELATED APPLICATIONS

The present application claims the benefit of U.S. provisional application No. 63/588,975, filed Oct. 9, 2023, the entire contents of which are incorporated by reference herein.

### FIELD

The present disclosure relates to the field of electric machines, and more particularly, propulsion motors for electric vehicles.

### BACKGROUND

In modern electric vehicle engine compartments, space is limited, and it is often necessary to reduce the packaging dimensions of the electric motor and other components in order to allow for all parts to fit within the engine compartment. Additionally, it is desirable to limit the number of parts required in the vehicle while still meeting electric motor and other vehicle operating requirements. Proper cooling of the electric machine components, including diodes, coil windings, and other associated parts is also needed in order to maintain performance of the electric machine and keep it in good working order.

The electrically excited synchronous motor (“EESM”) is commonly known and can be found in various applications, including motors for electric vehicles. The EESM has the advantage of being a high efficiency motor that is relatively inexpensive to manufacture, can be safely operated, and has high efficiency field-weakening operation. EESMs may be provided as a brushed electrical excited synchronous motor (i.e., “brushed EESM”) or an inductive electrical excited synchronous motor (i.e., “brushless EESM”).

One example of a brushed EESM is shown in FIG. 10A. The rotor 130 of the brushed EESM defines north/south poles provided in the form of coils that are wound around the core. Slip rings 114 transfer energy to the rotor coils via brushes 116 that touch the slip rings. Unfortunately, the physical engagement between the brushes 116 and the slip rings 114 can result in significant wear over time and reduce the life of the brushed EESM. The slip rings 114 and brushes 116 must also be sealed off from oil spray intended to cool and lubricate motor parts, thus resulting in additional parts in the electric machine. Moreover, the slip rings 114, brushes 116 and related components consume a significant amount of axial space in the EESM.

The brushless EESM does not require slip rings and brushes. In the brushless EESM, current is induced in the rotor coils via a rotary transformer. The rotary transformer includes a stationary primary coil and a moveable/rotating secondary coil. The rotating secondary coil is provided is attached to and rotates with the rotor shaft. The stationary primary coil is in close proximity to the rotating coil, but is fixed in relation to the housing. When the stationary primary coil is energized and the secondary coil rotates, current is induced in the secondary coil. The current from the rotating secondary coil is then transferred to the rotor coils. However, the current induced in the secondary coil is alternating current (“AC”), and the current flowing through the rotor coils needs to be direct current (“DC”). Therefore, a rectifier and an associated electronics package is required to convert the current from AC to DC. Advantageously, brushless EESM does not include brushes or other physical connections to transfer current to the rotor coils. Moreover, the axial length of the rotary transformer and the electronics package in the brushless EESM is significantly less than the slip rings and brushes of the brushed EESM, thus reducing the axial length of the electric machine.

While the brushless EESM provides inherent advantages over the brushed EESM, it would be of additional advantage to improve on current brushless EESM designs. For example, it would be advantageous to provide a brushless EESM with an axial length that is reduced even further from existing designs. It would also be advantageous to provide improved cooling and heat transfer for the electronics package of the brushless EESM. In association with this, it would be advantages to provide an EESM that offers these advantages with only limited component parts, thereby reducing the complexity and manufacturing costs of the electric machine.

### SUMMARY

A brushless electric machine is disclosed herein. In at least one embodiment, the electric machine includes a housing, a stator assembly, a rotor assembly, a rotary transformer, and a rectifier. The stator assembly is arranged within the housing and includes a stator winding provided on a stator core. The rotor assembly is also positioned within the housing with an airgap separating the rotor assembly from the stator assembly. The rotor assembly includes a rotor shaft, a rotor winding, and a balance ring. The rotary transformer is also positioned within the housing and includes a primary coil and a secondary coil. The rectifier includes a plurality of diodes positioned on the balance ring. The rectifier is electrically connected between the secondary coil and the rotor winding.

In at least one embodiment, an electric machine includes a rotor assembly positioned within a housing, the rotor assembly including a rotor shaft, a rotor core, and a dual component balance ring comprising a first component that is electrically isolated from a second component. The electric machine further includes a rotary transformer positioned within the housing, the rotary transformer including a primary coil and a secondary coil, the secondary coil positioned on a printed circuit board.

In at least one embodiment, a rotor assembly includes a rotor shaft, a rotor core, a rotor winding, a balance ring, and a plurality of diodes. The rotor core is positioned on the rotor shaft and the rotor winding is wound on the rotor core. The balance ring is positioned at one end of the rotor core and a plurality of diodes positioned on the balance ring.

The above described features and advantages, as well as others, will become more readily apparent to those of ordinary skill in the art by reference to the following detailed description and accompanying drawings. While it would be desirable to provide a brushless electric machine that provides one or more of these or other advantageous features as may be apparent to those reviewing this disclosure, the teachings disclosed herein extend to those embodiments which fall within the scope of the appended claims, regardless of whether they include or accomplish one or more of the advantages or features mentioned herein.

### BRIEF DESCRIPTION OF THE DRAWINGS

FIG. 1 shows a cutaway side view of an improved brushless electric motor including a rotary transformer with a secondary coil arranged on a printed circuit board, the electric motor further including rectifier diodes arranged on a balance ring of a rotor assembly;

FIG. 2 shows an isolated cross-sectional view of the rotary transformer and rotor assembly of FIG. 1;

FIG. 3 shows an enlarged view of the dotted line isolation block III of FIG. 2;

FIG. 4 shows a block diagram of components in an electronics package for the rotor assembly of FIG. 1;

FIG. 5 shows a perspective view of a two-piece balance ring for the rotor assembly of FIG. 1, the balance ring shown in isolation along with a press-fit diode;

FIG. 6A shows a side-by-side embodiment for the balance ring of FIG. 5;

FIG. 6B shows a stacked embodiment for the balance ring of FIG. 5;

FIG. 7 is a simple schematic diagram of the rotary transformer, rectifier arrangement with heat sink association, and field winding for the electrical machine of FIG. 1;

FIG. 8 shows a perspective view of the rotor assembly of FIG. 1 including a first balance ring, and a second balance ring with diodes, and interpolar plastic supports arranged on the rotor;

FIG. 9 is a cutaway perspective view of the rotor assembly of FIG. 8 illustrating the position of oil cooling paths;

FIG. 10A is a cutaway side view of a prior art brushed EESM with an outline square indicating the volume required for the brushed EESM;

FIG. 10B is a cutaway side view of the brushless EESM of FIG. 1 with the outline square of FIG. 10A imposed on the brushless EESM to illustrate the reduced axial of the brushless EESM.

### DESCRIPTION

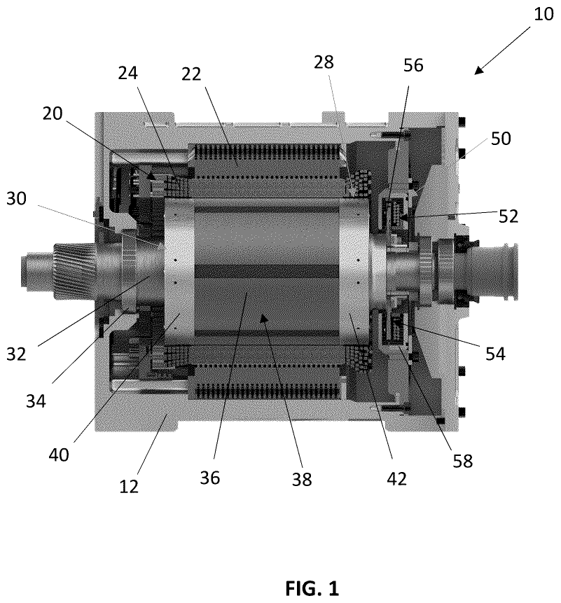

A brushless electric machine is disclosed herein. As shown in FIG. 1, the electric machine 10 includes a stator assembly 20 and a rotor assembly 30 arranged within a housing 12. The electric machine 10 further includes rotary transformer 50 including a primary coil 52 and a secondary coil 54. The primary coil 52 is stationary with respect to the housing 12 of the electric machine 10. The secondary coil 54 is arranged on a printed circuit board 56 and is configured to rotate within the housing 12 along with the rotor assembly 30. The rotor assembly 30 further includes a rectifier 74 that includes a plurality of diodes 76. The rectifier diodes 76 are arranged on a balance ring 80 of the rotor assembly, as described in further detail herein.

With continued reference to FIG. 1, the housing 12 of the electric machine is comprised of steel or other hardened metal material and is configured to retain both the stator assembly 20 and the rotor assembly 30. The housing 12 is particularly adapted for placement in the engine compartment of a vehicle, such as the electric motor compartment of an electric vehicle.

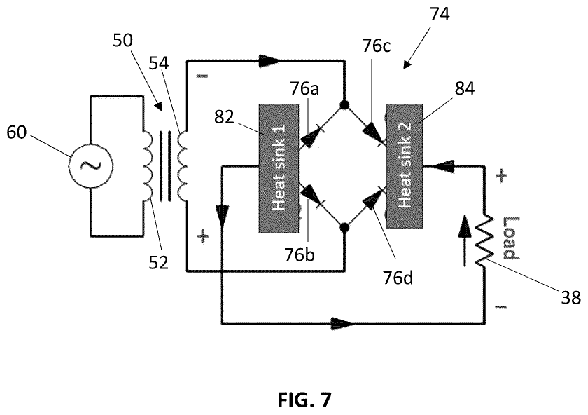

The stator assembly 20 (which may also be referred to herein as simply a “stator”) is fixedly secured within the housing 12. The stator assembly 20 includes a magnetic permeable stator core 22 and a plurality of stator windings 24 arranged in slots on the stator core. The stator windings 24 are multi-phase windings that are energized by a vehicle battery 60 (not shown in FIG. 1; see FIG. 7). A stator electronics package includes an inverter that converts DC voltage from the vehicle battery into AC voltage and results in AC current flowing through the stator windings.

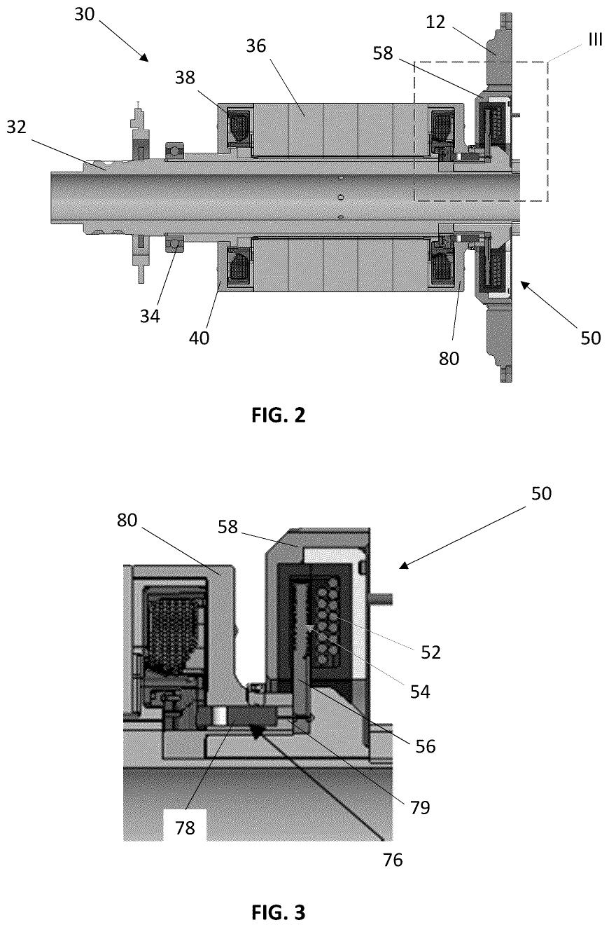

With reference now to FIGS. 1 and 2, the rotor assembly 30 (which may also be referred to herein as simply a “rotor”) is rotatably contained within the housing 12. The rotor assembly 30 includes a rotor shaft 32 that extends through the housing and the stator 20 and defines an axial direction for the electric machine 10. The rotor shaft 32 is supported by bearings 34 within the housing 12. The rotor shaft 32 is comprised of steel or other metal material and may be hollow in some embodiments, as shown in FIG. 2, or may be solid in other embodiments. A rotor core 36 is coupled to the rotor shaft 32. The rotor core 36 is separated from the stator core 22 by an airgap 28. The rotor core 36 is comprised of a magnetic permeable material and defines a plurality of rotor poles. Each rotor pole retains one of a plurality of rotor coils 38 that encircles the pole (which rotor coils may also be referred to as a rotor winding, rotor field coil or field coils). Balance rings 40, 80 are positioned at opposite ends of the rotor core 36. The balance rings 40, 80 act to balance the rotor assembly 30 within the housing 12 such that movement of the rotor 30 will not destabilize the electric machine 10 during operation. Balance rings are actively used to balance the rotors. After the rotors are completed, the rotor imbalance is measured and then the balance machine adds material, or subtracts material from (more often subtracted) the two balance rings to bring the rotor underneath the balance specification.

As best shown in FIGS. 2 and 3, the rotary transformer 50 is positioned at one end of the rotor shaft 32. The rotary transformer 50 includes a primary coil 52 and a secondary coil 54 that are arranged within a transformer housing 58. The primary coil 52 of the rotary transformer 50 is fixedly secured within the housing 12. The primary coil 52 encircles the rotor shaft 32, but does not engage the rotor shaft 32, and does not move with the rotor assembly 30. Similar to the stator windings, the primary coil 52 is configured to be energized by an electronics package that is coupled to a vehicle battery. As explained in further detail below, the electronics package transforms DC energy provided by the vehicle battery into AC flowing through the primary coil 52 of the rotary transformer 50.

The secondary coil 54 is positioned directly across from the primary coil 52 in the rotary transformer, with only a small airgap between the two coils 52, 54. The secondary coil 54 is arranged on a printed circuit board (PCB) 56 that is fixedly coupled to the rotor shaft 32 and extends radially outward from the rotor shaft 32. Accordingly, the secondary coil 54 is configured to rotate within the transformer housing 58, and is also configured to rotate within the motor housing 12 along with the rotor assembly 30. As explained in further detail below, an electronics package transforms AC current induced within the secondary coil into DC current that is delivered to the rotor coils 38.

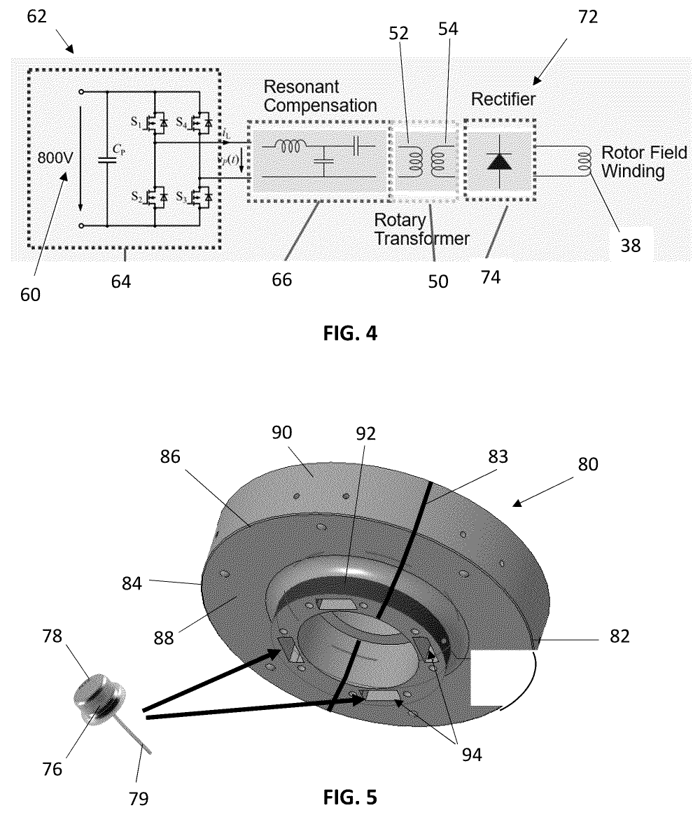

With reference now to FIG. 4, a block diagram of the electronic components of an electronics package associated with the rotary transformer 50 is shown. The electronic components coupled to the rotary transformer 50 include a vehicle battery 60 connected to a primary side package 62 and a secondary side package 72. The primary side package 62 includes an inverter 64 and a resonant compensation circuit 66. The secondary side package 72 includes a rectifier 74. The vehicle battery 60 may be any of various vehicle batteries used to power electric vehicles, such as lithium-ion (Li-ion) batteries (including Li-NMC, LFP, Li-NCA, etc.), nickel-metal hybrid batteries, or lead-acid batteries. The vehicle battery 60 is designed for high power-to-weight ratio and energy density.

In the embodiment of FIG. 4, the vehicle battery 60 is an 800V battery that provides DC power to an inverter 64. The inverter 64 receives DC current from the battery 60 and turns it into AC current. The AC current from the inverter 64 is passed through a resonant compensation circuit 66 that assists in optimizing power transfer, reducing energy loss, and improving efficiency. That AC current is then delivered to the primary coil of the rotary transformer 50. The rotary transformer 50 induces an AC current in the secondary coil 54 of the rotary transformer. That AC current is then delivered to the rectifier 74, which transforms the AC current into DC current. The DC current from the rectifier is then delivered to the rotor field windings 38.

With reference again to FIGS. 1 and 2, the brushless EESM 10 further includes two balance rings 40, 80 positioned at opposite ends of the rotor core 36. The balance rings 40, 80 are typically comprised of a non-magnetic material such as stainless steel, or aluminum, and have material strategically removed to enable the rotor to meet a maximum imbalance specification. In order to reduce the number of parts in the electric machine 10, one of the balance rings doubles as at least one of the diode heat sinks for the rectifier 74. In particular, in the embodiments disclosed herein, the balance ring 80 positioned closest to the rotary transformer 50 also serves as a diode heat sink.

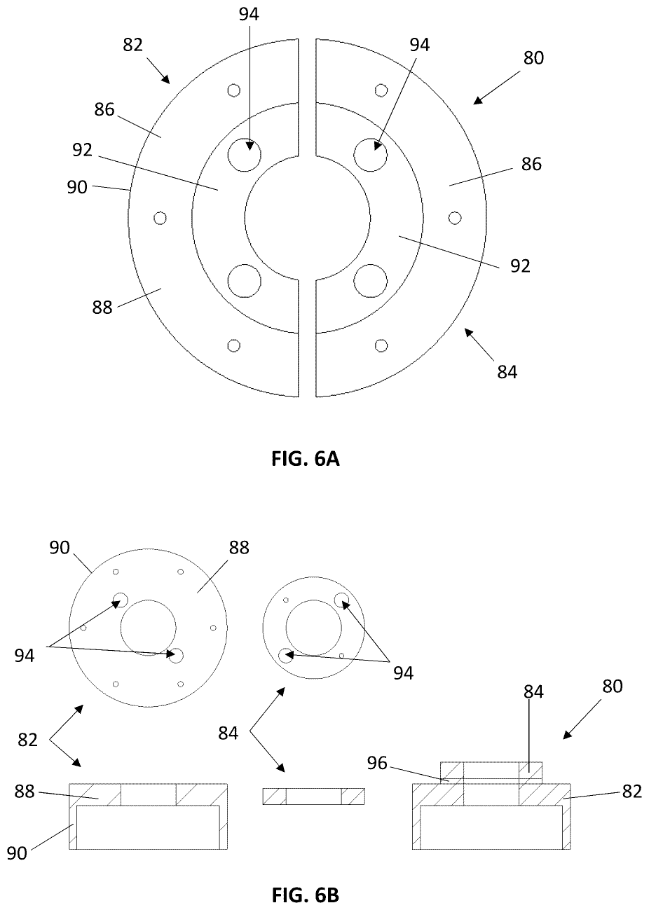

With reference now to FIGS. 5 and 6A, the balance ring 80 is separated into two electrically isolated pieces, including a first component 82 and a second component 84. As used herein, the term “electrically isolated” refers to two components with sufficient electrical insulation provided therebetween such that electrical current does not flow between the two components during normal operation of the electric machine. The electrical isolation may be provided by a simple air gap 83 that provides sufficient separation to insulate the first component 82 from the second component 84 to prevent, or may be provided by a polymer or other insulating material (not shown) positioned between the first component 82 and the second component 84. In the embodiment of FIGS. 5 and 6A, the balance ring 80 is split into two halves such that the first component 82 and the second component 84 are side-by-side (i.e., two different radially extending sides arranged at a common axial location) and symmetrical in shape.

When the balance ring 80 is viewed as a whole (i.e., the first component 82 and the second component 84 positioned side-by-side), it will be recognized that the balance ring 80 includes an outer diameter wheel portion 86 and an inner diameter ring portion 92 wherein the inner diameter ring portion 92 is coaxial with and axially raised relative to the outer diameter wheel portion 86. The outer diameter wheel portion 86 includes a radially-extending surface 88 and an outer cylindrical surface 90. The radially extending surface 88 is plate-like and disc shaped, and the outer cylindrical surface 90 extends axially from a perimeter edge of the radially extending surface 88 with a similar thickness. In other words, the outer cylindrical surface 90 is a circumferential surface that is generally perpendicular to the radially extending surface 88. Together, the radially extending surface 88 and the outer cylindrical surface 90 form a cap-like (or cup-like) structure that is relatively thin and is configured to fit over one end of the rotor core 36.

The inner diameter ring portion 92 of the balance ring 80 extends radially inward and axially outward from an inner perimeter of the outer diameter wheel portion 86. The thickness of the balance ring 80 is significantly greater at the inner diameter ring portion 92 than at the radially extending surface 88. A plurality of diode holes 94 are formed on a face of the inner diameter ring portion. Each diode hole 94 has a cross-sectional shape (which is typically a round shape) that is similar to that of the body of a diode 76 used to form the rectifier 74, and a depth that is sufficient to completely receive the body of said diode 76. Returning again to FIG. 3, it will be recognized that the depth of each diode hole 94 is greater than the thickness of the radially extending surface 88 of the balance ring 80. Accordingly, it will be recognized that the inner diameter ring portion 92 serves to provide a portion of the balance ring 80 with a sufficient thickness to receive the diodes 76. Advantageously, the diodes 76 are completely embedded in the diode holes 94 in the inner diameter ring 92, and together, the outer diameter wheel portion 86 and inner diameter ring 92 act as a heat sink for each diode 76.

In order to mount the diodes 76 in the diode holes 94, the diodes 76 are press-fit into the diode holes 94 with the entire body 78 of each diode completely received within the depth of the diode hole 94, and a lead 79 to the diode extending axially out of the diode hole 94. The leads 79 are all connected to the printed circuit board 56 of the rotary transformer 50 positioned adjacent to the balance ring 80. A mechanical connection, such as a weld, soldering, or adhesive may be used to further secure the lead of each diode to the PCB 56 (or wiring that leads to the PCB).

During operation of the electric machine, the diodes 76 generate heat, and each of the first component 82 and the second component 84 of the balance ring 80 act as a heat sink to dissipate heat from the diodes 76 that are arranged in the diode holes 94. As noted above, in the embodiment of FIGS. 5 and 6A, the two heat sinks (i.e., components 82 and 84) are side-by-side and therefore each heat sink comprises ½ the balance ring 40.

In the embodiment of FIG. 6A, each component 82, 84 of the balance ring 80 includes at least two diode holes 94 and the diodes 76 are connected together to form the rectifier 74. FIG. 7 shows a schematic arrangement of the rectifier 74, and the placement of the diodes 76 in association with each of the two heat sinks 82, 84 (i.e., which are provided by the first component 82 and the second component 84 of the balance ring 80). As shown in FIG. 7, two diodes 76a and 76b of the rectifier 74 are arranged on “Heat Sink 1” (i.e., first component 82 of the balance ring 80) and two diodes 76c and 76d of the rectifier 74 are arranged on “Heat Sink 2” (i.e., the second component 84 of the balance ring 80). One end the rotor field coil 38 (i.e., a first lead to the field coil) is connected to the surface of one heat sink (i.e., first component 82), and the opposite end of the rotor field coil 38 (i.e., a second lead to the field coil) is connected to the surface of the other heat sink (i.e., second component 84). Each connection to the heat sink is a mechanical connection, such as a weld or soldering that is used to secure the end of the rotor field coil 38 to the heat sink.

Together, the rotary transformer 50 and rectifier 74 serve to deliver DC current to the field winding 38. In operation, AC current is provided from the vehicle battery 60 to the primary coil 52 of the rotary transformer 50. Magnetic flux provides a coupling between the primary coil 52 and the secondary coil 54 of the rotary transformer 50, and an AC current is induced in the secondary coil 54. The AC current from the secondary coil 54 of the rotary transformer 50 is then delivered to the rectifier, which utilizes the four diodes 76a-76d mounted on the heat sinks (i.e., components 82 and 84 of the balance ring 80) to transform the AC current into DC current that is delivered to the field winding 38.

While FIGS. 5, 6A and 7 illustrate one embodiment of the balance ring 80 with rectifier diodes 76 mounted thereon, it will be recognized that other embodiments are contemplated. For example, FIG. 6B shows an alternative embodiment of the balance ring 80 wherein the two component balance ring 80 is provided by a first component 82 that is axially forward/rearward of a second component 84. Stated differently, in an alternative embodiment of the balance ring 80 as shown in FIG. 6B, one heat sink for the diodes 76 is provided by a first component 82 that serves as the balance ring itself and a second heat sink provided by a second component 84 that is electrically isolated from the first component and mounted axially forward or rearward from the first component. In this embodiment, the first component 82 is a unitary component that has the same general shape as the outer diameter wheel portion 86 of FIGS. 5 and 6A (i.e., including a radially extending surface 88 and a cylindrical outer surface 90), but in the embodiment of FIG. 6B the first component 82 is a unitary component that is not split into two different side-by-side components (as is the outer diameter wheel portion 86 in FIGS. 5 and 6A). In this embodiment, the depth of the radially extending surface 88 of the first component 82 is sufficient such that diode holes 94 in the first component 82 completely receive the body of the diodes 76 mounted therein. As shown in FIG. 6B, the second component 84 is provided by a smaller ring that is arranged in a different axial position from the first component 82 (i.e., axially forward or rearward from the first component 82). Again, the depth of this second component 84 is sufficient such that diode holes 94 in the second component completely receive the body of diodes mounted therein. An insulation ring 96 may be provide between the first component 82 and the second component 84 to assist in electrically isolating the first component 82 from the second component 84.

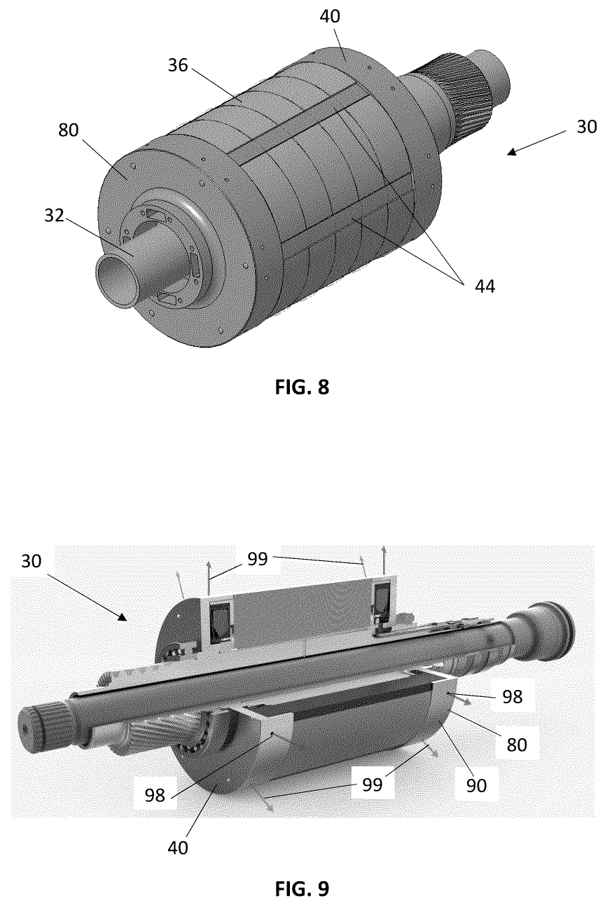

In view of the foregoing, it will be recognized that in each case of the balance rings (e.g., FIGS. 6A and 6B), the heat sinks (i.e., components 82 and 84) should be electrically isolated from each other and ground. Therefore methods and means used to attach the balance ring 80 to the rotor assembly should result in the balance rings being insulated from other metal parts of the rotor assembly. In some cases the rivets or screws used to attach the balance rings are screwed into the interpolar insulation supports 44 that extend axially along the rotor core 36, as shown in FIG. 8. The interpolar insulation supports 44 provide electrical isolation between the rotor coils that define poles on the rotor. The interpolar insulation supports may be formed of plastic or any of various other electrically insulative material sufficient to provide electrical isolation between the poles. The use of plastic material for the interpolar insulation supports 44 is advantageous because it allows metal rivets or screws to be used to attach the balance rings 40, 80 to the rotor core 36.

It will also be recognized from the disclosure herein that the design of the electric machine 10 is such that each of the rotary transformer 50 with PCB 56, rectifier 74 (including diodes 76), and balance ring heat sinks 82 and 84 are located in an oil cooling cavity of the electric machine near the rotor 30 and rotor coils 38. Cooling oil that is delivered to the rotor assembly 30 sprayed out of oil holes 98 in the cylindrical surface portion 90 of the balance rings 40, 80 via circumferential force during operation of the electric machine, as shown by arrows 99 in FIG. 9. As a result, the rotary transformer 50 (including PCB 56) and rectifier diodes 76 installed in the cooling cavity and are cooled by the oil which is sprayed from rotor holes in the balance rings 40, 80.

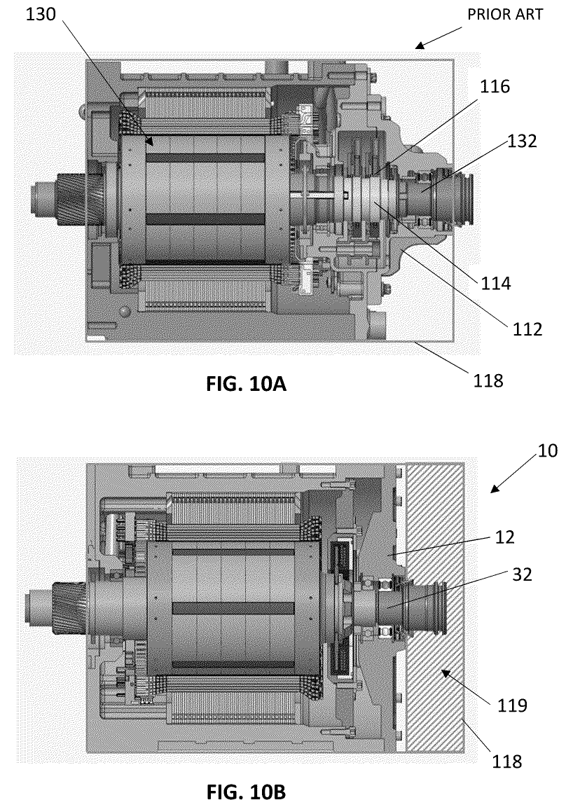

With reference now to FIGS. 10A and 10B, it will be further recognized that the axial length of the brushless EESM 10 disclosed herein is significantly less than prior art brushed EESM 110. Box 118 of FIG. 10A shows the space consumed between opposite ends of the rotor shaft 132 exiting the housing 112 in the brushed EESM. FIG. 10B shows the same box 118 superimposed over the brushless EESM 10 disclosed herein. It can be easily seen from FIG. 10B that the brushless EESM 10 occupies significantly less space in the axial direction than the prior art brushed EESM 110. In particular, the cross-hatching 119 within the box 118 of FIG. 10B indicates the saved axial space realized with the brushless EESM disclosed herein.

In view of all of the foregoing, it will be recognized that the design of the electric machine 10 in the form of a brushless EESM with rotary transformer 50 and press-fit diodes 76 arranged on the balance ring 80, as disclosed herein has numerous advantages. Those advantages include the following:
reduction of the length of the machine to improve packaging;
all of the parts of the rotary transformer are mounted in the oil cooling cavity;
the diodes are effectively cooled due to being located in heat sinks; and
a reduced number of parts as a result of the secondary coil being included on the PCB and the diodes are pressed into heat sinks.

Although the various embodiments of a brushless electric machine with balance ring diodes have been provided herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An electric machine comprising:
a housing:
a stator assembly positioned within the housing, the stator assembly including a stator winding;
a rotor assembly positioned within the housing with an airgap separating the rotor assembly from the stator assembly, the rotor assembly including a rotor shaft, a rotor winding, and a balance ring;
a rotary transformer positioned within the housing, the rotary transformer including a primary coil and a secondary coil; and
a rectifier including a plurality of diodes positioned on the balance ring, the rectifier electrically connected between the secondary coil and the rotor winding.

2. The electric machine of claim 1, wherein the secondary coil is provided on a printed circuit board.

3. The electric machine of claim 2, wherein the printed circuit board is fixedly connected to the rotor shaft.

4. The electric machine of claim 3, the balance ring including a plurality of diode holes and the plurality of diodes are arranged in the plurality of diode holes.

5. The electric machine of claim 4, wherein the plurality of diodes are press-fit into the plurality of diode holes.

6. The electric machine of claim 4 wherein the balance ring provides a heat sink for the plurality of diodes.

7. The electric machine of claim 6 wherein the balance ring includes a first component that is electrically isolated from a second component.

8. The electric machine of claim 7 wherein the first and second component are positioned side-by-side at a common axial location.

9. The electric machine of claim 8 wherein the balance ring includes an outer diameter wheel portion and an inner diameter ring portion that is coaxial with and axially raised relative to the outer diameter wheel portion, wherein the plurality of diode holes are arranged on the inner diameter ring.

10. The electric machine of claim 9 wherein the outer diameter wheel portion includes a radially extending surface and an outer cylindrical surface.

11. The electric machine of claim 10 wherein the outer cylindrical surface includes a plurality of oil holes.

12. The electric machine of claim 7 wherein the second component is axially stacked on the first component.

13. The electric machine of claim 7 wherein the rotor winding includes a first end connected to the first component of the balance ring and a second end connected to the second component of the balance ring.

14. The electric machine of claim 13 wherein the connection between the first end of the rotor winding and the first component is a weld.

15. An electric machine comprising:
a rotor assembly positioned within a housing, the rotor assembly including a rotor shaft, a rotor core, and a dual component balance ring comprising a first component that is electrically isolated from a second component; and
a rotary transformer positioned within the housing, the rotary transformer including a primary coil and a secondary coil, the secondary coil positioned on a printed circuit board.

16. The electric machine of claim 15 further comprising a rectifier including a plurality of diodes positioned on the dual component balance ring.

17. The electric machine of claim 15 wherein the dual component balance ring includes a first component and a second component that is electrically isolated from the first component.

18. A rotor assembly comprising:
a rotor shaft;
a rotor core positioned on the rotor shaft;
a rotor winding wound on the rotor core;
a balance ring positioned at one end of the rotor core; and
a plurality of diodes positioned on the balance ring.

19. The rotor assembly of claim 18, wherein the plurality of diodes are connected to form a rectifier, the rectifier connected to the rotor winding, the balance ring including:
a first component;
a second component electrically isolated from the first component; and
the plurality of diodes positioned on the first component and the second component.

20. The rotor assembly of claim 19 wherein the plurality of diodes are press-fit into diode holes on the first component and the second component of the balance ring.
